(19) United States
(12) Patent Application Publication
(10) Pub. No.: US 2025/0047337 A1
(43) Pub. Date: Feb. 6, 2025

(54) METHOD AND DEVICE FOR DETERMINING PRE-CODING WEIGHTS, AND ASSOCIATED COMPUTER PROGRAM

(71) Applicant: FONDATION B-COM, CESSON SEVIGNE (FR)

(72) Inventors: Luc LE MAGOAROU, THORIGNE-FOUILLARD (FR); Stéphane PAQUELET, Rennes (FR)

(21) Appl. No.: 18/720,479

(22) PCT Filed: Dec. 6, 2022
(86) PCT No.: PCT/EP2022/084652

§ 371 Date: Jun. 24, 2024

(30) Foreign Application Priority Data
Dec. 16, 2021 (FR) FR2113724

(51) Int. Cl. H04B 7/0456

(52) U.S. Cl. CPC H04B 7/0456

(57) ABSTRACT

The present invention relates to a method for determining pre-coding weights (w) based on a position vector (I) representing the position of a communication terminal within a communication system, said method being implemented by way of an artificial neural network (NN), the method comprising a step of determining the pre-coding weights (w) by way of the artificial neural network (NN) receiving the position vector (I) at input and supplying the pre-coding weights (w) at output. A transmission method, a device for determining pre-coding weights, a transmission device and a computer program are also described.

### TECHNICAL FIELD OF THE INVENTION

The present invention relates to the technical field of telecommunication.

More particularly, it relates to a method and device for determining pre-coding weights, as well as an associated computer program.

### STATE OF THE ART

In order to optimize the transmission of data in a communication system, it is known to configure pre-coders adapted to perform a pre-coding of the electromagnetic signals to be transmitted by the antennas forming the communication system. Some methods for determining pre-coders are based for example on a channel estimation method aiming to have a better knowledge of the current state of the communication channels used by the communication system. Such a method is described for example in the article “Noncooperative cellular wireless with unlimited numbers of base station antennas”, Marzetta, T. L., IEEE transactions on wireless communications, 9 (11), 3590-3600, 2010.

Other methods for determining pre-coders are based on a simplified approach considering a propagation of signals along a direct “line-of-sight” channel. In this case, the pre-coders are determined based on the users' positions, such as for example a mobile terminal. The article “Location based beamforming”, R. Maiberger, D. Ezri and M. Erlihson, 2010 IEEE 26-th Convention of Electrical and Electronics Engineers in Israel, 2010, pp. 000184-000187, doi: 10.1109/EEEI.2010.5661954, describes such a so-called “Location Based Beamforming” (LBB) pre-coding method.

However, these methods cannot be applied to all the environments, e.g. urban environment, due to the direct line-of-sight propagation hypothesis.

### DISCLOSURE OF THE INVENTION

In this context, the present invention proposes to improve the determination of pre-coders in order for them to be reliably determined whatever the environment in which the signals propagate.

More particularly, it is proposed according to the invention a method for determining pre-coding weights based on a position vector representing the position of a communication terminal included in a communication system, said method being implemented using an artificial neural network, the method comprising a step of determining the pre-coding weights using the artificial neural network receiving the position vector as an input and outputting the pre-coding weights.

Thus, thanks to the use of the artificial neural network, the pre-coding weights are obtained directly from the position vector of the communication terminal, whatever the initial position thereof. No additional direct line-of-sight hypothesis is required here to determine these pre-coding weights. The method thus finds a particularly advantageous application in urban environment, in which the topology (with the presence of buildings, for example) cannot be associated with direct line-of-sight propagation.

Other non-limiting and advantageous features of the method according to the invention, taken individually or according to all the technically possible combinations, are the following:
the artificial neural network is implemented using a plurality of frequency vectors, each frequency vector comprising frequency components, the frequency components of the frequency vectors of said plurality being distributed according to a predetermined distribution;
the method also comprises a step of applying the position vector to the input of a first part of the artificial neural network, in order to produce intermediate data at the output of said first part, said intermediate data being respectively obtained, for the frequency vectors of the plurality, by application of a trigonometric function to the result of a scalar product between the position vector and the frequency vector concerned;
the step of determining the pre-coding weights is implemented using a second part of the artificial neural network receiving the intermediate data as an input and outputting the pre-coding weights;
the frequency components of the frequency vectors of said plurality are distributed within a predetermined range of spatial frequencies;
the frequency components are randomly distributed within said range of spatial frequencies according to a normal distribution;
it is provided, previously to the application step, a step of training the artificial neural network in such a way as to determine second weighting coefficients respectively associated with nodes of the second part of the artificial neural network;
during the training step, determining the second weighting coefficients is based on minimizing a cost function depending on the position vector and on data characterizing the transmission through communication channels included in the communication system;
the second part of the artificial neural network comprises rectifier-type activation functions; and
the second part of the artificial neural network is a multilayer perceptron.

The present invention also relates to a transmission method comprising:
a step a determining pre-coding weights by implementing a determination method as defined hereinabove,
a step of pre-coding data to be transmitted using the pre-coding weights determined, and
a step of transmitting the pre-coded data.

The present invention also relates to a device for determining pre-coding weights based on a position vector representing the position of a communication terminal included in a communication system, said device being adapted to determine pre-coding weights using the artificial neural network receiving the position vector as an input and outputting the pre-coding weights.

The artificial neural network can be adapted to use a plurality of frequency vectors, each frequency vector comprising frequency components, the frequency components of the frequency vectors of said plurality being distributed according to a predetermined distribution.

The determination device can also comprise a module for applying the position vector to the input of a first part of the artificial neural network, in order to produce intermediate data at the output of said first part, said intermediate data being respectively obtained, for the frequency vectors of the plurality, by application of a trigonometric function to the result of a scalar product between the position vector and the frequency vector concerned.

The determination device may also comprise a module for implementing the neural network in order to determine pre-coding weights using a second part of the artificial neural network receiving the intermediate data as an input and outputting the pre-coding weights.

The present invention also relates to a transmission device comprising:
a device for determining pre-coding weights as introduced hereinabove,
a module for pre-coding data to be transmitted using the pre-coding weights determined, and
a module for transmitting the pre-coded data.

The present invention finally relates to a computer program comprising instructions executable by a processor and adapted to implement a method as introduced hereinabove when these instructions are executed by the processor. The invention also relates to a non-transitory, computer readable recording medium, storing a computer program as mentioned hereinabove.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

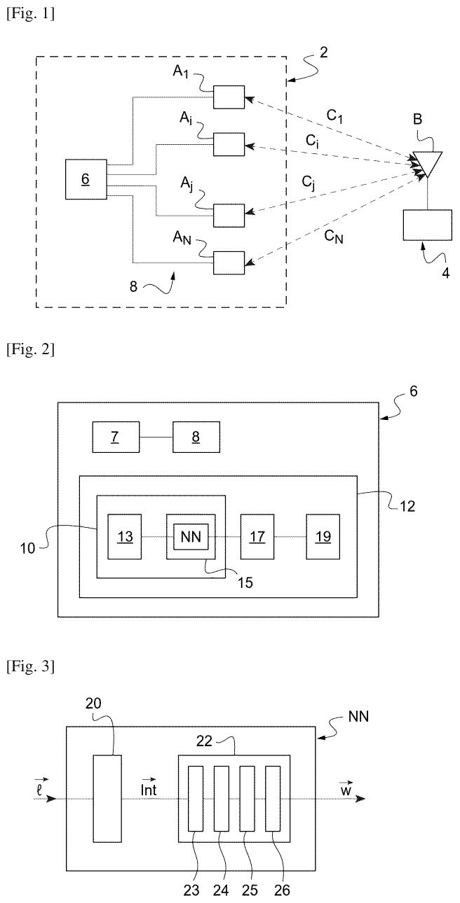

FIG. 1 shows a telecommunication system involved in the present invention,

FIG. 2 shows, as a block diagram, a control unit configured to implement the method for determining pre-coding weights according to the invention,

FIG. 3 shows an example of an artificial neural network used in the control unit of FIG. 2,

FIG. 4 shows, as a flowchart, an example of a method for determining pre-coding weights according to the invention, and

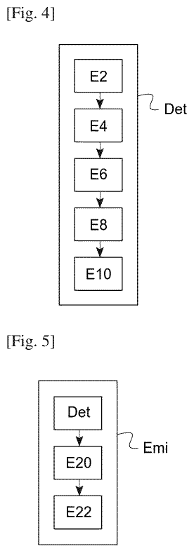

FIG. 5 shows, as a flowchart, an example of transmission method according to the invention.

It is to be noted that, in these figures, the structural and/or functional elements common to the different alternatives can have the same references.

FIG. 1 schematically shows a communication system in which the invention can be implemented.

This communication system includes a communication unit 2 and a communication terminal 4.

The communication unit 2 comprises a control unit 6 and a plurality of antennas A₁, Aᵢ, Aⱼ, A_{N} forming an array of antennas 8. The number of antennas A₁, Aᵢ, Aⱼ, A_{N} of the array of antennas 8 is here equal to N. For example, here, N is equal to 64.

The control unit 6 is connected to each of the antennas A₁, Aᵢ, Aⱼ, A_{N} in such a way as to receive signals representative of electromagnetic signals received by each of the antennas A₁, Aᵢ, Aⱼ, A_{N}. The control unit 6 can also control the transmission of electromagnetic signals by each of the antennas A₁, Aᵢ, Aⱼ, A_{N}.

The set of transmission antennas A₁, Aᵢ, Aⱼ, A_{N} transmits electromagnetic signals (generally representing data to be transmitted, coded by symbols) via a plurality of communication channels C₁, Cᵢ, Cⱼ, C_{Nc}, Nc being a non-zero integer. In FIG. 1, a communication channel is shown, for example, between each of the antennas A₁, Aᵢ, Aⱼ, A_{N} of the communication unit 2 and an antenna B of the communication terminal 4 (therefore, in this case, Nc=N).

The transmission between the communication system and the communication terminal 4, via these communication channels C₁, Cᵢ, Cⱼ, C_{Nc} is modeled by a vector h of dimension Nc (corresponding to the number of communication channels).

The communication terminal 4 includes an antenna B, using which the communication terminal 4 can transmit electromagnetic signals (towards in particular the communication unit 2). The position of the communication terminal 4 is represented by a position vector I. This position vector I is of dimension D, D being a non-zero integer. In practice, the position vector I for example of dimension 2 (in the case of a planar representation) or 3 (for example of dimension 3 if a height coordinate is also taken into account).

In practice, the position vector I is for example determined using a satellite positioning system (or GNSS for “Global Navigation Satellite System”) or sensors, for example cameras or sensors using the LIDAR (for “Laser Imaging Detection And Ranging”) or RADAR (for “RAdio Detection And Ranging”) technology, for acquiring representation of the environment of interest. As an alternative, the position vector I can be determined using the transmission of pilot signals to determine the direction of arrival of the transmitted signal.

The communication system could comprise other electronic devices provided with at least one antenna and hence capable of exchanging electromagnetic signals with the communication unit 2. We are in this case in a situation of the type MU-MIMO (“Multi User-Multiple-Input Multiple-Output”) system. A single communication terminal 4 is however shown in FIG. 1 to simplify the present disclosure.

In practice, the communication unit 2 is for example a base station of a mobile phone network. The communication terminal 4 is then for example in this case a mobile terminal.

FIG. 2 shows, as a block diagram, the control unit 6 that comprises a device 10 for determining pre-coding weights and a transmission device 12 in accordance with an exemplary embodiment of the invention.

The control unit 6 comprises a processor 7 and a memory 8.

The device 10 and the transmission device 12 are formed by a set of functional modules. The device 10 is designed to implement an artificial neural network NN. This device 10 comprises, for example, an application module 13 and a module 15 for implementing an artificial neural network NN. As shown in FIG. 2, the transmission device 12 comprises for example a pre-coding module 17 and a transmission module 19.

Each of the different modules described is for example made using computer program instructions adapted to implement the module in question when these instructions are executed by the processor 7 of the control unit 6.

FIG. 3 shows the structure of the artificial neural network NN. It comprises a first part 20 and a second part 22.

The first part 20 of the artificial neural network NN is configured to receive as an input the position vector I (of dimension D) representing the position of the communication terminal 4 and outputting intermediate data Int representing functions of the position of the communication terminal 4 for a plurality of frequency vectors Bᵢ, with i an integer between 1 and R. The plurality of frequency vectors Bᵢ is here formed of R frequency vectors Bᵢ.

In this description, the word “frequency” relates to spatial frequencies. Each frequency vector Bᵢ is of dimension D (as the position vector I).

The matrix B, of dimension RxD, each row of which corresponds to one of the frequency vectors Bᵢ, respectively, of the set of R frequency vectors Bᵢ is also defined.

More particularly, it is considered here that each frequency vector Bᵢ comprises D frequency components. The different frequency components of the plurality of frequency vectors Bᵢ are distributed within a predetermined range of spatial frequencies.

The predetermined range of spatial frequencies is for example characterized by its extent.

Here, the frequency components are randomly distributed according a predetermined distribution. This predetermined distribution has for example a finite or infinite support.

For example, the frequency components are randomly distributed within the predetermined range of spatial frequencies. They can for example be obtained by random draw. As an alternative, the frequency components can be predetermined values so as to be distributed according to a particular distribution.

For example here, the frequency components are distributed according to a normal distribution with zero expectation and variance σ². For example here, this variance is defined so that 1/σ=50 m.

Advantageously, the first layer 20 of the artificial neural network NN determines the intermediate data Int on the basis of so-called random sinusoid components γ (or “Random Fourier Features”). These functions γ depend on the position vector I and the frequency vectors Bᵢ. The intermediate data may be represented as a vector, each element of which is formed by a component γ.

More explicitly, the random sinusoid components γ are expressed, for each frequency vector Bᵢ, as follows:

$$γ ( {B}_{i} l ) = {[ cos ( 2 π {B}_{i} l ) , sin ( 2 π {B}_{i} l ) ]}^{T} \qquad [ Math . 1 ]$$

with I the position vector associated with the communication vector 4 and Bᵢ an associated frequency vector and .^{T} corresponding to the matrix transposition operator.

Therefore, each component γ is obtained by application of trigonometric functions to the result of a scalar product between the position vector I and the frequency vector Bᵢ concerned.

More particularly, each component γ has two elements: a first element obtained by application of a cosine function to a result proportional to the scalar product between the position vector and the frequency vector concerned and a second element obtained by application of a sine function to a result proportional to the scalar product between the position vector and the frequency vector concerned. Each component γ is thus of dimension 2.

The intermediate data Int are thus obtained by determination of the components γ for the plurality of frequency vectors Bᵢ (for the R frequency vectors considered here). The intermediate data Int are then for example represented by a vector of dimension 2R.

Here, this first layer 20 of the artificial neural network NN is fixed, i.e. parameters characterizing the first part 20 are initially fixed to a predetermined value and are maintained to this predetermined value. In other words, the parameters of the first layer 20 are not subsequently adjusted (for example during a training step of the artificial neural network NN as described hereinafter).

This first layer has then for object to artificially pre-construct signals, based on the position vector, in such a way that the intermediate data, obtained at the output of the first layer 20, represent all the frequency components of the predetermined range of spatial frequencies.

Thanks to the first layer 20 of the artificial neural network NN, the position vector is adapted into intermediate data Int in order to be used by the second part 22 of the artificial neural network NN to determine the pre-coding weights that will then allow a pre-coding of the electromagnetic signals to be transmitted by the antennas A₁, Aᵢ, Aⱼ, A_{N} of the communication system. The pre-coding weights form for example a pre-coding vector.

This second part 22 is thus configured to receive as an input the intermediate data Int, obtained at the output of the first part 20 of the artificial neural network NN. The second part 22 is also configured to output pre-coding weights w.

This second part 22 is of the MultiLayer Perceptron type (or MLP). Conventionally, this second part 22 then comprises a plurality of layers 23, 24, 25, 26 (for example Q layers, Q being a positive number). Each layer 23, 24, 25, 26 has for example a number M of neurons, M being a positive integer.

Each layer 23, 24, 25, 26 comprises the application of a rectifier-type function and/or the implementation of a matrix product. In other words, this second part 22 of the artificial neural network NN is based on activation functions of the ReLU (“Rectified Linear Unit”) type.

Here, the second part 22 of the artificial neural network NN comprises for example four layers 23, 24, 25, 26.

The second part 22 of the artificial neural network NN is structured with nodes forming the different layers 23, 24, 25, 26. These nodes are characterized by a plurality of weighting coefficients that may be adjusted, previously to the implementation of the method for determining pre-coding weights itself, thanks to a training phase as described hereinafter in a preliminary method.

More explicitly, the first layer 23 of the second part 22 of the artificial neural network NN receives as an input the intermediate data Int of dimension 2R. The nodes forming the first layer 23 apply a rectifier-type function then operate the multiplication of the result obtained by a matrix A₁ of dimension M×2R. Data Int1, of dimension M, are thus obtained at the output of the first layer 23.

These data Int1 are then provided to the input of the second layer 24. The nodes forming the second layer 24 apply a rectifier-type function then operate the multiplication of the result obtained by a matrix A2 of dimension M×M. Data Int2, of dimension M, are thus obtained at the output of the second layer 24.

These data Int2 are then provided to the input of the third layer 25. The nodes forming the third layer 25 apply a rectifier-type function then operate the multiplication of the result obtained by a matrix A3 of dimension M×M. Data Int3, of dimension M, are thus obtained at the output of the third layer 25.

Finally, these data Int3 are provided to the input of the fourth layer 26. The nodes forming the third layer 26 apply a rectifier-type function then operate the multiplication of the result obtained by a matrix A4 of dimension 2N×M. The pre-coding weights w, of dimension 2N, are obtained at the output of the fourth layer 26.

The second part 22 of the artificial neural network NN thus outputs the pre-coding weights w that are for example in the form of a vector of dimension 2N (N being the number of antennas). More particularly, the second part 22 provides a decomposition in real and imaginary parts of the pre-coding weights w.

FIG. 4 is a flowchart showing an example of pre-coding weight determination method Det implemented in the context described hereinabove.

Previously to the implementation of the method, a preliminary method is implemented in order to perform a training of the neural network NN. More particularly, this preliminary method allows a training of the second part 22 of the artificial neural network NN because, as indicated hereinabove, the first part 20 of the artificial neural network NN is fixed.

In practice, this preliminary method makes it possible to determine the weighting coefficients of the second part 22 of the artificial neural network NN.

This preliminary method comprises a first step of initializing the weighting coefficients of the second part 22 to initial values. These initial values are for example random values.

Then, the processor 7 of the control unit receives sets of initial data representing the vector h characterizing the communication channel and the associated position vector I. The processor 7 here receives as many sets of initial data {h, I} as there are antennas (e.g., here, N). The part of the initial data that relates to the vector h is for example, here, obtained in a conventional manner on the basis of pilot signals sent and of channel estimation methods. They are determined, for example, upstream of the implementation of the preliminary method.

The preliminary method finally comprises the step of training the artificial neural network NN. As mentioned hereinabove, this step corresponds to the training of the second part 22 of the artificial neural network NN.

During this training step, the artificial neural network NN receives as an input (thus as an input of the first part 20) the various sets of initial data {h, I} and adjusts the weighting coefficients of the second part 22 in order to obtain the pre-coding weights corresponding to each of the couples formed by the vector h and the position vector I, respectively, of the set of initial data concerned. The sets of initial data {h, I} then represent a training communication channel and the associated position.

In practice, this training step is based on minimizing a cost function CF. This cost function CF depends on the position vector I and on the vector h.

The cost function CF is for example defined by the following expression:

$$CF = 2 - \frac{2}{Nc} {\sum }_{i = 1}^{Nc} \frac{{\vert {P ( {l}_{i} )}^{H} {h}_{i} \vert}^{2}}{{‖ {h}_{i} ‖}_{2}^{2}} \qquad [ Math . 2 ]$$

with {hi, li} the couple of initial data associated with the antenna i, Nc the number of communication channels, P (li) the value produced at the output of the artificial neural network NN when the position vector Ii is applied to the input of this same artificial neural network NN during the training phase, the notation ∥x∥₂ corresponding to the Euclidean norm of the vector x, |a| the module of the complex number a and .^{H} the “conjugate transpose” operator.

This cost function makes it possible to quantify the misalignment between the pre-coding weights obtained at the end of the training step (based on the initial data) and the known communication channel (from the initial data). In other words, this cost function makes it possible to quantify the misalignment between the pre-coding weights and the training communication channel.

Therefore, if the cost function is close to 0, the pre-coding weights and the training communication channel are perfectly aligned. On the other hand, if the cost function has a value close to 2, this means that the pre-coding weights and the training communication channel are orthogonal (and in this case, no signal transmission is possible).

Finally, the weighting coefficients are modified so as to minimize the cost function, for example during several iterations, until obtaining the optimum weighting coefficients that minimize efficiently the cost function CF. The optimum weighting coefficients are then used in the pre-coding weight determination method Det described hereinafter.

The pre-coding weight determination method Det w is thus implemented after the preliminary method.

As shown in FIG. 4, the determination method Det starts at step E2, in which the control unit 6 receives the position vector I.

At step E4, the position vector I received is applied to the input of the artificial neural network NN, and more particularly the input of the first part 20 of the artificial neural network NN.

This first part 20 then outputs the intermediate data Int (step E6).

As shown in FIG. 4, the determination method Det continues with step E8. During this step, the intermediate data Int are provided to the input of the second part 22 of the artificial neural network NN.

The method then comprises the step E10 of determining the pre-coding weights w. These pre-coding weights w are then obtained at the output of the second part 22 (and hence the output of the artificial neural network NN).

Thanks to the use of the two-part structure of the artificial neural network and to the specific features of these two parts, the pre-coding weights are obtained from the position vector of the communication terminal, whatever the initial position thereof. The method is particularly advantageous in the case where the communication terminal is not located in a direct line-of-sight of the base stations of the communication system.

The invention also relates to a pre-coded data transmission method Emi. This transmission method Emi follows the above-described pre-coding weight determination method. FIG. 5 shows, as a flowchart, an example of transmission method implemented according to the invention.

The transmission method Emi first comprises a step of determining pre-coding weights according to the above-mentioned determination method Det. Pre-coding weights w are thus obtained at the end of this step.

The transmission method Emi then comprises a step E20. During this step, the control unit 6 uses the pre-coding weights obtained in order to pre-code the data to be transmitted. More particularly, the pre-coding weights are applied to each of the transmission antennas in order to determine pre-coded data to be transmitted in the communication system. The control unit 6 thus generates these pre-coded data using the pre-coding weights.

Finally, the transmission method Emi comprises a step E22 of transmitting the pre-coded data obtained. These pre-coded data are for example transmitted by the antennas to the communication terminal 4.

1. A method for determining pre-coding weights based on a position vector representing the position of a communication terminal included in a communication system, said method being implemented using an artificial neural network, the method comprising:
determining the pre-coding weights using the artificial neural network receiving the position vector as an input, and
outputting the pre-coding weights.

2. The method according to claim 1, wherein the artificial neural network is implemented using a plurality of frequency vectors, each of the plurality of frequency vectors comprising frequency components, the frequency components of the plurality of frequency vectors being distributed according to a predetermined distribution, the method also comprising:
applying the position vector to the input of a first part of the artificial neural network, in order to produce intermediate data at an output of said first part, said intermediate data being respectively obtained, for each given one the plurality of frequency vectors, by application of a trigonometric function to a result of a scalar product between the position vector and the given frequency vector.

3. The method according to claim 2, wherein determining the pre-coding weights is implemented using a second part of the artificial neural network receiving the intermediate data as an input and outputting the pre-coding weights.

4. The method according to claim 1, wherein the frequency components are randomly distributed within a range of spatial frequencies according to a normal distribution.

5. The method according to claim 2, further comprising, prior to applying the position vector to the input of the first part of the artificial neural network:
training the artificial neural network in such a way as to determine second weighting coefficients respectively associated with nodes of the second part of the artificial neural network.

6. The method according to claim 5, wherein determining the second weighting coefficients is based on minimizing a cost function depending on the position vector and on data characterizing the transmission through communication channels included in the communication system.

7. The method according to claim 5, further comprising, prior to training the artificial neural network:
initializing the second weighting coefficients to random values.

8. The method according to claim 3, wherein the second part of the artificial neural network comprises rectifier-type activation functions.

9. The method according to claim 3, wherein the second part of the artificial neural network is a multilayer perceptron.

10. A transmission method comprising:
determining the pre-coding weights by implementing the determination method according to claim 1,
pre-coding data to be transmitted using the determined pre-coding weights, and
transmitting the pre-coded data.

11. A device for determining pre-coding weights based on a position vector representing the position of a communication terminal included in a communication system, the device being adapted to determine the pre-coding weights using an artificial neural network receiving the position vector as an input and outputting the pre-coding weights.

12. The determination device according to claim 11, wherein the artificial neural network is adapted to use a plurality of frequency vectors, each of the plurality of frequency vectors comprising frequency components, the frequency components of the plurality of frequency vectors being distributed according to a predetermined distribution, wherein the device further comprises:
a module configured to apply the position vector to the input of a first part of the artificial neural network, in order to produce intermediate data at an output of said first part, said intermediate data being respectively obtained, for each given one of the plurality of frequency vectors, by application of a trigonometric function to a result of a scalar product between the position vector and the given frequency vector, and
a module configured to implement the artificial neural network in order to determine the pre-coding weights using a second part of the artificial neural network receiving the intermediate data as an input and outputting the pre-coding weights.

13. A transmission device comprising:
the device for determining the pre-coding weights according to claim 11,
a module configured to pre-code data to be transmitted using the determined pre-coding weights, and
a module configured to transmit the pre-coded data.

14. A non-transitory computer-readable medium on which is stored a computer program comprising instructions executable by a processor that, when executed by the processor, cause the processor to implement the method according to claim 1.

15. The method according to claim 2, wherein the frequency components are randomly distributed within a range of spatial frequencies according to a normal distribution.

16. The method according to claim 3, wherein the frequency components are randomly distributed within a range of spatial frequencies according to a normal distribution.

17. The method according to claim 2, further comprising, prior to applying the position vector to the input of the first part of the artificial neural network:
training the artificial neural network in such a way as to determine second weighting coefficients respectively associated with nodes of the second part of the artificial neural network.

18. The method according to claim 3, further comprising, prior to applying the position vector to the input of the first part of the artificial neural network:
training the artificial neural network in such a way as to determine second weighting coefficients respectively associated with nodes of the second part of the artificial neural network.

19. The method according to claim 4, further comprising, prior to applying the position vector to the input of the first part of the artificial neural network:
training the artificial neural network in such a way as to determine second weighting coefficients respectively associated with nodes of the second part of the artificial neural network.

20. The method according to claim 6, further comprising, prior to training the artificial neural network:
initializing the second weighting coefficients to random values.
